(19) United States
(12) Patent Application Publication
(10) Pub. No.: US 2024/0072371 A1
(43) Pub. Date: Feb. 29, 2024

(54) BATTERY PACK

(71) Applicant: SK On Co., Ltd., Seoul (KR)

(72) Inventor: Ja Sung YUN, Daejeon (KR)

(21) Appl. No.: 18/330,763

(22) Filed: Jun. 7, 2023

(30) Foreign Application Priority Data
Aug. 24, 2022 (KR) 10-2022-0105834

(51) Int. Cl. H01M 50/367; H01M 10/658; H01M 50/271

(52) U.S. Cl. CPC H01M 50/367; H01M 10/658; H01M 50/271

(57) ABSTRACT

The battery pack of the present disclosure comprises a pack housing forming a plurality of areas; a plurality of battery modules each disposed in the plurality of areas; and a cover which is disposed above the plurality of battery modules and on which a plurality of exhaust devices corresponding to each of the plurality of battery modules are formed, wherein each of the plurality of exhaust devices is be opened or closed by the pressure of a gas generated at a corresponding battery module among the plurality of battery modules.

### CROSS-REFERENCE TO RELATED PATENT APPLICATION

The present application claims priority under 35 U.S.C. § 119(a) to Korean patent application number 10-2022-0105834 filed on Aug. 24, 2022, in the Korean Intellectual Property Office, the entire disclosure of which is incorporated by reference herein.

### BACKGROUND OF THE INVENTION

### 1. Field

The present disclosure relates to a secondary battery, specifically, a battery pack.

### 2. Description of the Related Art

As an energy power source for driving various electronic devices such as smartphones, laptops, vehicles, and drones, demand for secondary batteries is rapidly increasing.

In particular, as a secondary battery for driving a vehicle or the like, research on a battery pack is being actively conducted. A battery pack may comprise a plurality of battery modules. A battery module may comprise a plurality of battery cells. A battery cell may be a minimum unit of a battery that is capable of repeatedly charging and discharging.

When a high-temperature gas is generated in a particular battery module in a battery pack, a technology for suppressing heat propagation to other battery modules is required.

### SUMMARY OF THE INVENTION

An Example of the present disclosure provides a battery pack with improved thermal stability.

A battery pack according to one Example comprises a pack housing forming a plurality of areas; a plurality of battery modules each disposed in the plurality of areas; and a cover which is disposed above the plurality of battery modules and on which a plurality of exhaust devices corresponding to each of the plurality of battery modules are formed, wherein each of the plurality of exhaust devices may be opened or closed by the pressure of a gas generated at a corresponding battery module among the plurality of battery modules.

In an Example, each of the plurality of exhaust devices may be opened when the pressure of a gas generated at a corresponding battery module is equal to or higher than a reference value.

In an Example, each of the plurality of exhaust devices may be closed when the pressure of a gas generated at a corresponding battery module is lower than a reference value.

In an Example, each of the plurality of exhaust devices may comprise a rotatable door and a hinge coupled to the door.

In an Example, the cover may comprise a plurality of module covers each corresponding to the plurality of areas, and one or more exhaust devices among the plurality of exhaust devices may be formed on each of the plurality of module covers.

In an Example, a heat insulating member disposed between each of the plurality of battery modules and each of the plurality of module covers may be further included.

In an Example, the pack housing may comprise a lower plate in which an inner wall and an outer wall sectioning a plurality of areas are coupled; and an upper plate forming an upper space of a cover, wherein the outer wall may comprise a vent hole that allows communication between the upper space with an external space of the pack housing.

In an Example, a gas generated at one battery module among a plurality of battery modules may be discharged to an external space through the upper space and the vent hole when an exhaust device located above the battery module among the plurality of exhaust devices is opened.

In an Example, the height of an outer wall may be greater than the height of the inner wall.

In an Example, a portion of the cover may be disposed between the top of the outer wall and the bottom of the upper plate.

In an Example, each of the plurality of battery modules may comprise a plurality of battery cells stacked in one direction.

A battery pack according to one Example may comprise a lower plate in which an inner wall and an outer wall sectioning a plurality of areas are coupled; a plurality of battery modules each disposed in a plurality of areas; a cover which is disposed above the plurality of battery modules and on which a plurality of exhaust devices corresponding to each of the plurality of battery modules are formed; and an upper plate forming an upper space of the cover, wherein each of the plurality of exhaust devices may be opened or closed by the pressure of a gas generated at a corresponding battery module among the plurality of battery modules.

An Example of the present disclosure may provide a battery pack with improved thermal stability.

An Example of the present disclosure may suppress heat propagation to other battery modules due to a high-temperature gas generated at a particular battery module.

An Example of the present disclosure may suppress thermal damage to other battery modules due to a high-temperature gas generated at a particular battery module.

### BRIEF DESCRIPTION OF THE DRAWINGS

FIG. 1 is a diagram for explaining a battery pack according to one Example.

FIG. 2 is a cross-sectional view of a battery pack according to one Example.

FIG. 3 is another cross-sectional view of a battery pack according to one Example.

FIG. 4 is a diagram for explaining a path through which a gas is discharged according to one Example.

FIG. 5 is a cross-sectional view for explaining a path through which a gas is discharged according to one Example.

FIG. 6 is a diagram for explaining a module cover according to one Example.

### DETAILED DESCRIPTION

Structural or functional descriptions of Examples disclosed in the present specification or application are merely illustrated for the purpose of describing Examples according to the technical principle of the present disclosure. In addition, Examples according to the technical principle of the present disclosure may be implemented in various forms other than the Examples disclosed in the present specification or application. In addition, the technical principle of the present disclosure is not to be construed as being limited to the Examples described in this specification or application.

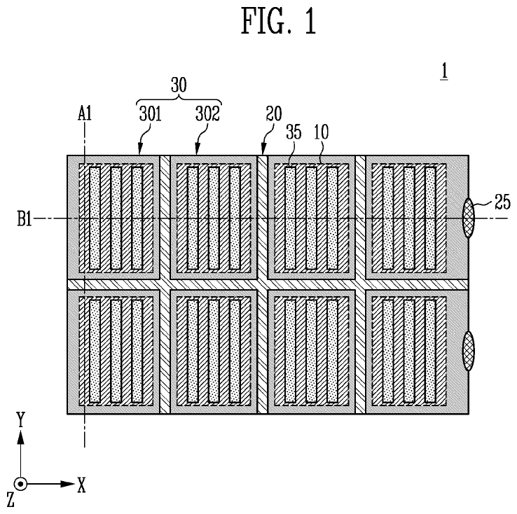

FIG. 1 is a diagram for explaining a battery pack 1 according to one Example.

Specifically, FIG. 1 is a floor plan of a battery pack 1 according to one Example. Referring to FIG. 1, a battery pack 1 may comprise a battery module 10, a pack housing 20, and a cover 30.

The battery module 10 may comprise a plurality of battery cells. The battery cell may be a secondary battery that is capable of repeatedly charging and discharging. For example, the battery cell may be a lithium ion battery. The battery cells may be stacked in one direction. For example, the battery cells may be stacked in the X-axis direction within the battery module 10.

The pack housing 20 may form a plurality of areas therein. The plurality of areas may be sectioned by a structure such as an inner wall of the pack housing 20. For example, each area may be an area in which a structure such as an inner wall of the pack housing 20 does not exist on the XY-plane. The plurality of battery modules 10 may each be disposed in the plurality of areas. In other words, the battery module 10 may be disposed in each area.

In an Example, the material of the pack housing 20 may be a metal material such as aluminum or iron, or an alloy of metals. However, this is only one Example, and the material of the pack housing 20 may comprise a thermosetting resin or may further comprise various other materials. As a specific example, the material of the pack housing 20 may comprise a thermosetting resin or may comprise a thermosetting resin and other materials having special properties. Here, the special properties may be flame retardancy or heat resistance. The other materials may be, for example, a fiber material such as carbon fiber or glass fiber.

The pack housing 20 may comprise a vent hole 25. The vent hole 25 represents an opening that allows communication between an internal space and an external space of the pack housing 20.

The cover 30 may be disposed above the plurality of battery modules 10.

In an Example, the cover 30 may comprise a plurality of module covers 301, 302. Each of the module covers 301, 302 may be disposed on above one battery module 10. Each of the module covers 301, 302 may seal or open, through an exhaust device 35, an area in which the battery module 10 is disposed.

The cover 30 may comprise a plurality of exhaust devices 35. Each exhaust device 35 may be formed on top of a battery module 10. At least one exhaust device 35 may be formed above each battery module 10. In other words, at least one exhaust device 35 may be formed on each of the module covers 301, 302.

Each of the exhaust devices 35 may be opened or closed. In an Example, the exhaust device 35 may be implemented as a device that opens and closes an opening by using an opening and closing method such as a hinge method or a valve method.

Each of the exhaust devices 35 may be opened or closed according to the pressure of a gas generated at a corresponding battery module 10. The gas may comprise at least one selected from the group consisting of carbon dioxide (CO₂), carbon monoxide (CO), acetylene (C₂H₂), ethylene (C₂H₄), methane (CH₄), hydrogen fluoride (HF), and hydrogen (H2). However, this is only one Example, and the components of the gas may be variously modified according to the type of electrolyte included in a battery cell.

According to an Example of the present disclosure, a battery pack 1 with improved thermal stability may be provided. Hereinafter, specific Examples will be described with reference to the accompanying drawings.

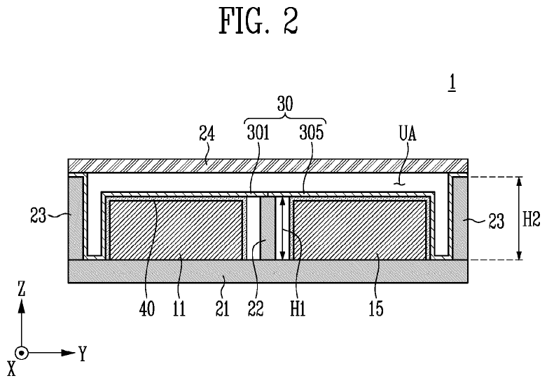

FIG. 2 is a cross-sectional view of a battery pack 1 according to one Example.

Specifically, FIG. 2 is a cross-sectional view of the battery pack 1 on line A1 illustrated in FIG. 1. Referring to FIGS. 1 and 2, the pack housing 20 may comprise a lower plate 21, an inner wall 22, an outer wall 23, and an upper plate 24.

The lower plate 21 may be coupled to the inner wall 22 and the outer wall 23. In an Example, the lower plate 21 may be manufactured as an integral component with at least one of the inner wall 22 and the outer wall 23, or may be manufactured as an independent component. When the lower plate 21 is manufactured as an independent component from the inner wall 22 and the outer wall 23, the lower plate 21 may be coupled to the inner wall 22 and the outer wall 23 by using a method such as bolting or welding.

The inner wall 22 may section a plurality of areas. For example, the inner wall 22 may be disposed on the upper surface of the lower plate 21 to form a plurality of areas in which battery modules 11, 15 are disposed. The plurality of areas may be arranged in the X-axis direction and the Y-axis direction. Each of the plurality of areas may be an area of the lower plate 21 excluding areas where the inner wall 22 and the outer wall 23 are disposed.

The outer wall 23 may be coupled to an edge of the lower plate 21. For example, the outer wall 23 may be disposed on a side surface of the lower plate 21 or on a top surface of the lower plate 21 to surround an outer side or an outer upper end of the lower plate 21.

The upper plate 24 may form an upper space UA of the cover 30. To this end, the upper plate 24 may be placed on top of the outer wall 23. In other words, the upper space UA may be a space between the upper plate 24 and the cover 30. The upper space UA may function as a passage through which a gas introduced from the battery module 11, 15 moves.

In an Example, the height H2 of the outer wall 23 may be greater than the height H1 of the inner wall 22. Here, the height H1, H2 may be the length in the Z-axis direction. In this case, a gas introduced from the battery module 11, 15 into an upper space UA may move smoothly.

The battery module 11, 15 may be disposed in an area sectioned by the inner wall 22. The battery module 11, 15 may be supported by the lower plate 21.

A module cover 301, 305 may be disposed above the battery modules 11, 15. In other words, the module cover 301, 305 may be disposed above an area where the battery module 11, 15 is disposed. The module cover 301, 305 may seal an area where the battery module 11, 15 is disposed. The module covers 301, 305 may be manufactured an integral component with each other or as independent components.

In an Example, a portion of the module cover 301, 305 may be disposed on top of the inner wall 22. Here, the portion may be one of the outer side ends. The inner wall 22 and the module cover 301, 305 may be coupled according to a method such as bolting or welding.

In an Example, a portion of the module cover 301, 305 may be disposed between the top of the outer wall 23 and the bottom of the upper plate 24. Here, the portion may be the other one of the outer ends. In addition, the outer wall 23, the module cover 301, 305, and the upper plate 24 may be coupled according to a method such as bolting or welding. However, this is only one Example, and in a state where a portion of the module cover 301, 305 is not disposed between the top of the outer wall 23 and the bottom of the upper plate 24, the top of the outer wall 23 and the bottom of the upper plate 24 may be directly coupled.

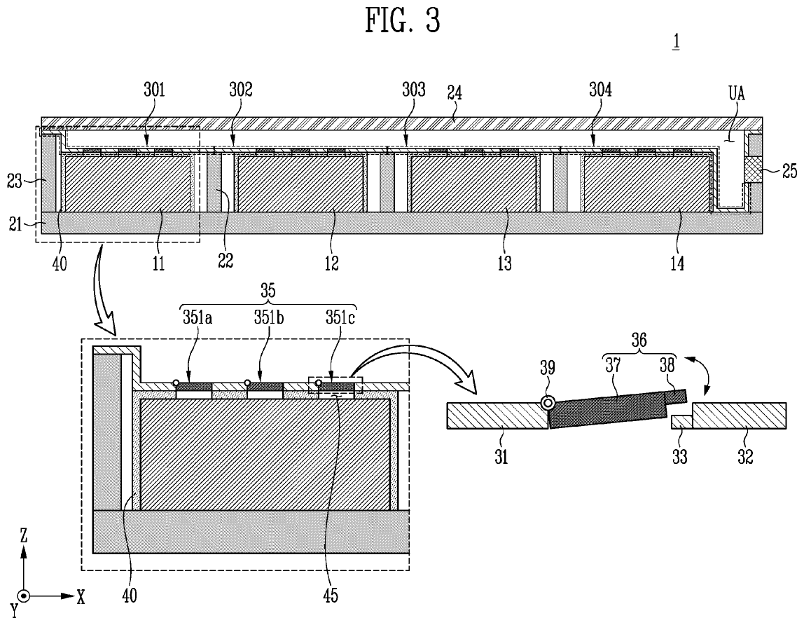

FIG. 3 is another cross-sectional view of a battery pack according to one Example.

Specifically, FIG. 3 is a cross-sectional view of the battery pack 1 on line B1 illustrated in FIG. 1. Referring to FIG. 3, a plurality of areas may be sectioned by the inner wall 22 and the outer wall 23 coupled to the lower plate 21. The plurality of areas may be arranged along the X-axis direction. A battery module 11-14 may be disposed in each area. A module cover 301-304 may be disposed on top of the battery module 11-14.

The outer wall 23 may comprise a vent hole 25. The vent hole 25 may allow communication between an upper space UA and an external space of the pack housing 20. The vent hole 25 may be formed in at least one of the outer walls 23.

Referring to FIGS. 1 and 3, the cover 30 may comprise a plurality of module covers 301-304. The module covers 301-304 may comprise an exhaust device 35. The exhaust device 35 can be opened or closed. The number of exhaust devices 35 included in one module cover may be one or more. For example, exhaust devices 35 included in one module cover may comprise a first exhaust device 351a, a second exhaust device 351b, and a third exhaust device 351c.

In an Example, the exhaust device 35 may be closed when the pressure of a gas generated at a corresponding battery module among the plurality of battery modules 11-14 is lower than a reference value. In an Example, the exhaust device 35 may be opened when the pressure of a gas generated at a corresponding battery module among the plurality of battery modules 11-14 is equal to or higher than a reference value. Here, the exhaust device 35 corresponding to the battery modules 11-14 may refer to the exhaust device 35 located above the battery modules 11-14.

In an Example, the exhaust device 35 may comprise a rotatable door 36 and a hinge 39. The door 36 may be coupled to the hinge 39. The door 36 may rotate with the hinge 39 as a rotational axis. The hinge 39 may be coupled to a first plate 31 of a module cover 301-304. For example, the hinge 39 may be coupled to a left top of the door 36 and a right top of the first plate 31.

The door 36 may rotate according to the pressure of a gas. Here, the gas may be a gas existing in a lower space (or a lower area) of the door 36. The lower space of the door 36 represents the lower space 45 of the module cover 301-304. For example, the lower space of the module cover 301-304 may be an space between the lower plate 21, the inner wall 22 or the outer wall 23, and the module cover 301-304.

The door 36 may comprise a body 37 and a stopper 38.

A portion of the body 37 may be coupled to the stopper 38. For example, a right side surface of the body 37 may be coupled to the left side surface of the stopper 38. In an Example, the height of the body 37 may be greater than the height of the stopper 38. Here, the height may be the length in the Z-axis direction. A portion of the body 37 may be coupled to the hinge 39. For example, the left top of the body 37 may be coupled to the hinge 39. However, this is only one Example, and the shape or coupling location of each of the body 37 and the stopper 38 may be variously modified.

The stopper 38 may be engaged with a stopper socket 33 coupled to a second plate 32 of the module covers 301-304, or spaced apart therefrom. For example, when the stopper 38 and the stopper socket 33 are engaged with each other, a lower space of the door 36 may be sealed. For example, when the stopper 38 is spaced apart from the stopper socket 33, the lower space of the door 36 may be opened.

As a specific example, when a gas is generated at the first battery module 11, the pressure of the gas in the lower space of the first module cover 301 may increase. In a state where the gas pressure is lower than a reference value, the stopper 38 of the door 36 may maintain a state of being engaged with the stopper socket 33. In this case, the lower space of the first module cover 301 may remain sealed. In addition, when a gas is generated in the first battery module 11 and the increased gas pressure exceeds a reference value, the door 36 may rotate. In this case, the lower space of the first module cover 301 may be changed to an open state. However, this is only one Example, and an exhaust device 35 may be implemented as a device that opens and closes an opening in various ways such as a valve method.

In an Example, the battery pack 1 may further comprise a heat insulating member 40. The heat insulating member 40 may comprise a material having heat insulating properties due to a low thermal conductivity. For example, the heat insulating member 40 may comprise one or more materials selected from the group consisting of silicate, mica, glass fiber, and mineral fiber.

The insulating member 40 may be disposed between a battery module 11-14 and a module cover 301-304. For example, the insulating member 40 may be disposed between the first battery module 11 and the first module cover 301 to surround the first battery module 11.

In an Example, the heat insulating member 40 may not be disposed in a lower space of an exhaust device 35. Therefore, the heat insulation member 40 may be disposed in an area between a battery module 11-14 and a module cover 301-304 excluding a lower space of the exhaust device 35.

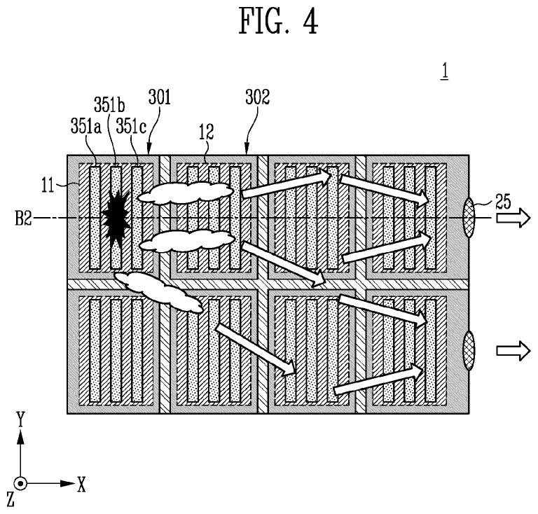

FIG. 4 is a diagram for explaining a path through which a gas is discharged according to one Example.

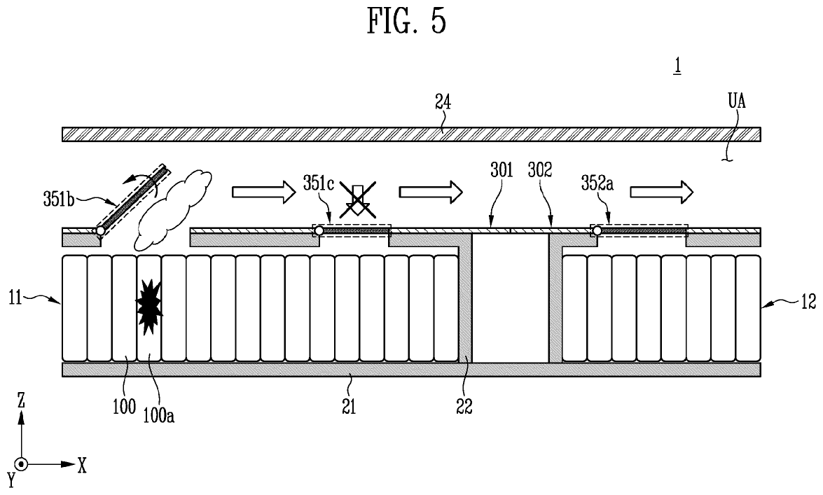

FIG. 5 is a cross-sectional view for explaining a path through which a gas is discharged according to one Example.

Referring to FIGS. 4 and 5, the battery pack 1 may comprise a plurality of battery modules 11, 12. A first module cover 301 may be disposed on top of a first battery module 11, and a second module cover 302 may be disposed on top of a second battery module 12. The first module cover 301 may comprise exhaust devices 351a, 351b, 351c, and the second module cover 302 may comprise an exhaust device 352a.

The battery modules 11, 12 may include a plurality of battery cells 100 and 100a. The battery cells 100 and 100a may be stacked in one direction within the battery modules 11, 12. For example, the battery cells 100 and 100a may be stacked in the X-axis direction.

In an Example, a gas may be generated at a particular battery module among the battery modules 11, 12. Specifically, a gas may be generated inside a particular battery cell among the battery cells 100, 100a included in the battery modules 11,12. For example, a gas may be generated inside a particular battery cell due to various causes such as overcharging, overdischarging, overheating, external shock, or defect. When the internal pressure of a battery cell becomes higher than a predetermined level due to a generated gas, the gas inside the battery cell may be discharged to the outside of the battery cell.

Hereinafter, a case will be assumed in which a gas is discharged from the first battery cell 100a included in the first battery module 11 among the plurality of battery modules 11 and 12.

First, the exhaust devices 351a, 351b, 351c of the first module cover 301 may close a lower space of the exhaust devices 351a, 351b, 351c to prevent communication with an upper space UA.

In addition, when the gas pressure in the lower space of the second exhaust device 351b of the first module cover 301 becomes equal to or greater than a reference value due to the gas discharged from the first battery cell 100a, the second exhaust device 351b may open the lower space of the second exhaust device 351b to allow communication with the upper space UA. Here, the second exhaust device 351b may be an exhaust device that is closest to the first battery cell 100a among the exhaust devices 351a, 351b, 351c of the first module cover 301. On the other hand, when the gas pressure in the lower space of the first exhaust device 351a and the third exhaust device 351c is lower than a reference value, the first exhaust device 351a and the third exhaust device 351c may maintain a closed state.

In addition, when the exhaust device 351b located above the first battery module 11 among the plurality of exhaust devices 351a, 351b, 351c, 352a is opened, the gas generated at the first battery module 11 among the plurality of battery modules 11, 12 may be discharged to an external space through the upper space UA and the vent hole 25.

As described above, Examples of the present disclosure may suppress propagation of heat due to a high-temperature gas generated at a particular battery module to other battery modules. In addition, Examples of the present disclosure may suppress thermal damage to other battery modules due to a high-temperature gas generated at a particular battery module.

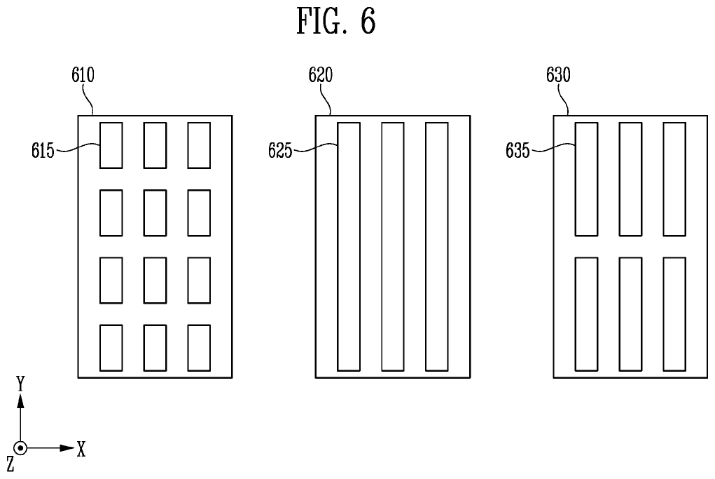

FIG. 6 is a diagram for explaining a module cover according to one Example.

Referring to FIG. 6, exhaust devices 615, 625, 635 formed on module covers 610, 620, 630 according to an Example may be arranged in rows and columns.

For example, exhaust devices 615 included in the first module cover 610 may be arranged 4x3. Exhaust devices 625 included in the second module cover 620 may be arranged 1x3. Exhaust devices 635 included in the third module cover 630 may be arranged 2x3.

Here, a row may represent the Y-axis and a column may represent the X-axis. For example, the X-axis may be the direction of the short side of a battery cell and the direction in which battery cells are stacked, and the Y-axis may be the direction of the long side of the battery cell.

In an Example, the module covers 301, 302 illustrated in FIG. 1 may be implemented in one form of the module covers 610, 620, 630 illustrated in FIG. 6. However, this is only one Example, and the number of exhaust devices 615, 625, 635 formed on the module covers 610, 620, 630 may be one, or may be variously modified to have a number and arrangement different from those of FIG. 6.

What is claimed is:

1. A battery pack comprising:
a pack housing forming a plurality of areas;
a plurality of battery modules each disposed in the plurality of areas; and
a cover which is disposed above the plurality of battery modules and on which a plurality of exhaust devices corresponding to each of the plurality of battery modules are formed,
wherein each of the plurality of exhaust devices is be opened or closed by the pressure of a gas generated at a corresponding battery module among the plurality of battery modules.

2. The battery pack according to claim 1, wherein each of the plurality of exhaust devices is opened when the pressure of a gas generated at a corresponding battery module is equal to or higher than a reference value.

3. The battery pack according to claim 1, wherein each of the plurality of exhaust devices is closed when the pressure of a gas generated at a corresponding battery module is lower than a reference value.

4. The battery pack according to claim 1, wherein each of the plurality of exhaust devices comprises a rotatable door and a hinge coupled to the door.

5. The battery pack according to claim 1, wherein the cover comprises a plurality of module covers each corresponding to the plurality of areas, and one or more exhaust devices among the plurality of exhaust devices is formed on each of the plurality of module covers.

6. The battery pack according to claim 1, further comprising a heat insulating member disposed between each of the plurality of battery modules and each of the plurality of module covers.

7. The battery pack according to claim 1, wherein the pack housing comprises a lower plate in which an inner wall and an outer wall sectioning a plurality of areas are coupled;
and an upper plate forming an upper space of a cover, wherein the outer wall comprises a vent hole that allows communication between the upper space with an external space of the pack housing.

8. The battery pack according to claim 7, wherein a gas generated at one battery module among a plurality of battery modules is discharged to an external space through the upper space and the vent hole when an exhaust device located above the battery module among the plurality of exhaust devices is opened.

9. The battery pack according to claim 7, wherein the height of an outer wall is greater than the height of the inner wall.

10. The battery pack according to claim 7, wherein a portion of the cover is disposed between the top of the outer wall and the bottom of the upper plate.

11. The battery pack according to claim 1, wherein each of the plurality of battery modules comprises a plurality of battery cells stacked in one direction.

12. A battery pack comprising:
a lower plate in which an inner wall and an outer wall sectioning a plurality of areas are coupled;
a plurality of battery modules each disposed in a plurality of areas;
a cover which is disposed above the plurality of battery modules and on which a plurality of exhaust devices corresponding to each of the plurality of battery modules are formed; and
an upper plate forming an upper space of the cover,
wherein each of the plurality of exhaust devices may be opened or closed by the pressure of a gas generated at a corresponding battery module among the plurality of battery modules.
